(19) United States
(12) Patent Application Publication
(10) Pub. No.: US 2024/0045251 A1
(43) Pub. Date: Feb. 8, 2024

(54) SPLICING DISPLAY MODULE AND DISPLAY DEVICE

(71) Applicants: Huizhou China Star Optoelectronics Display Co., Ltd., Huizhou (CN); TCL China Star Optoelectronics Technology Co., Ltd., Shenzhen (CN)

(72) Inventors: Yao CHEN, Huizhou (CN); Min Wang, Huizhou (CN)

(21) Appl. No.: 17/642,714

(22) PCT Filed: Feb. 25, 2022
(86) PCT No.: PCT/CN2022/077929

§ 371 Date: Mar. 14, 2022

(30) Foreign Application Priority Data
Jan. 27, 2022 (CN) 202210099662.3

(51) Int. Cl. G02F 1/1333; G02F 1/1345; G02F 1/13357

(52) U.S. Cl. CPC G02F 1/13336; G02F 1/13452; G02F 1/133608

(57) ABSTRACT

A splicing display module and a display device are provided, and the splicing display module includes: a first liquid crystal display module including a first display unit and a first backlight unit; a first liquid crystal display module including a second display unit and a first backlight unit, wherein the first display unit and the second display unit form a first splicing seam; an auxiliary display panel located in the first splicing seam; a connector, wherein an end of the connector is connected with the auxiliary display panel, and another end of the connector is connected with the first backlight unit.

### FIELD OF INVENTION

The present application relates to the field of display technologies, and more particularly to a splicing display module and a display device.

### BACKGROUND OF INVENTION

With the development of flat-panel display technology, major manufacturers have launched larger-sized display panels. Due to the limitation of the production process, when a size of a display panel cannot be made larger, a splicing display device comes into being. The splicing display device has a display performance of a large scene and can bring an immersive visual experience to the user, so it is widely used in advertising display, publicity, exhibition, and other occasions. However, there are physical seams that cannot be eliminated between modules of the splicing display device, which are visible to the naked eye, thus destroying continuity of display images and affecting the display performance.

During the research and practice of the prior art, the inventor of the present application found that with the rapid development of an outdoor display market, large size and high resolution have become a development direction of the outdoor display. A conventional liquid crystal display panel (LCD) not only has low cost and high resolution, but as a splicing screen, it cannot eliminate seams, which affects a visual performance. However, a sub-millimeter light-emitting diode (mini-LED) panel and a micro light-emitting diode (micro-LED) panel are still immature in a small-pitch process, the resolution is not as good as that of the LCD, and the cost is too high. Therefore, solving a seam issue of LCD splicing screen has become a key breakthrough point that needs to be solved urgently.

### SUMMARY OF INVENTION

The present application provides a splicing display module and a display device, so as to solve issues of splicing of liquid crystal splicing screens.

On the one hand, the application provides a splicing display module, which includes:
a first liquid crystal display module comprising a first display unit and a first backlight unit, wherein the first display unit is disposed on the first backlight unit;
a second liquid crystal display module comprising a second display unit and a second backlight unit, wherein the second display unit is disposed on the second backlight unit, the first display unit and the second display unit are disposed at intervals to form a first splicing seam;
an auxiliary display panel located in the first splicing seam, wherein two opposite ends of the auxiliary display panel are respectively connected with the first display unit and the second display unit;
a connector, wherein an end of the connector is connected with the auxiliary display panel, and another end of the connector is connected with the first backlight unit.

In the splicing display module of the present application, the splicing display module further comprises:

a positioning component disposed on the connector and the first backlight unit, wherein the connector and the first backlight unit are positioned and matched and are fixedly connected by a fastener, the fastener passes through the positioning component.

In the splicing display module of the present application, the positioning component comprises a first mounting hole and a second mounting hole;

the first mounting hole is disposed on the connector, the second mounting hole is disposed on a side of the first backlight unit facing the second backlight unit, and the fastener passes through the first mounting hole and the second mounting hole to connect the connector and the first backlight unit.

In the splicing display module of the present application, the fastener is a threaded fastener, and the fastener is threadedly connected with the positioning component.

In the splicing display module of the present application, the positioning component comprises:
a third mounting hole disposed on one of the connector and the second backlight unit;
a positioning protrusion disposed on the other of the connector and the second backlight unit, and the third mounting hole is matched with the positioning protrusion.

In the splicing display module of the present application, the first backlight unit comprises:
a first back plate comprising a first bottom plate and a first side plate formed by bending an edge of the first bottom plate, and the connector is connected with the first side plate.

In the splicing display module of the present application, the second backlight unit comprises:
a second back plate comprising a second bottom plate and a second side plate formed by bending an edge of the second bottom plate.

In the splicing display module of the present application, the connector is connected with the second side plate or is disposed at a distance from the second side plate.

In the splicing display module of the present application, the first display unit has a first light-emitting surface, and the first light-emitting surface is disposed away from the first backlight unit;
the second display unit has a second light-emitting surface, and the second light-emitting surface is disposed away from the second backlight unit;
the auxiliary display panel comprises a third light-emitting surface and a backlight surface disposed opposite to each other, and the connector is disposed on the backlight surface.

In the splicing display module of the present application, two ends of the auxiliary display panel are respectively overlapped with edges of surfaces of the first light-emitting surface and the second light-emitting surface.

In the splicing display module of the present application, the connector comprises a first connection portion and a second connection portion disposed to cross each other, a normal line of the first connection portion and a normal line of the backlight surface are disposed in a same direction, the first connection portion is bonded to the backlight surface, and the second connection portion is connected to the first backlight unit.

In the splicing display module of the present application, the first connection portion and the second connection portion are integrally formed.

In the splicing display module of the present application, the first backlight unit and the second backlight unit are disposed at intervals to form a second splicing seam, a gap of the first splicing seam is larger than a gap of the second splicing seam, and the connector is partially disposed in the first splicing seam and partially disposed in the second splicing seam.

In the splicing display module of the present application, the connector is a plastic piece, and a shape of the connector is a plate-like structure, a net-like structure, or a column-like structure.

In the splicing display module of the present application, the splicing display module further comprises:
a display control device electrically connected to the first liquid crystal display module, the second liquid crystal display module, and the auxiliary display panel, wherein the display control device is used to control a synchronous display of the first liquid crystal display module, the second liquid crystal display module, and the auxiliary display panel.

In the splicing display module of the present application, the auxiliary display panel is a top-emitting OELD display panel;
the auxiliary display panel comprises a substrate, a driving circuit layer, an organic light-emitting layer, and an encapsulation layer disposed in sequence from top to bottom, and the connector is connected to the substrate.

On the other hand, the present application further provides a display device including a splicing display module, wherein the splicing display module comprises:
a first liquid crystal display module comprising a first display unit and a first backlight unit, wherein the first display unit is disposed on the first backlight unit;
a second liquid crystal display module comprising a second display unit and a second backlight unit, wherein the second display unit is disposed on the second backlight unit, the first display unit and the second display unit are disposed at intervals to form a first splicing seam;
an auxiliary display panel located in the first splicing seam, wherein two opposite ends of the auxiliary display panel are respectively connected with the first display unit and the second display unit;
a connector, wherein an end of the connector is connected with the auxiliary display panel, and another end of the connector is connected with the first backlight unit.

In the display device of the present application, the splicing display module further comprises:
a positioning component disposed on the connector and the first backlight unit, wherein the connector and the first backlight unit are positioned and matched and are fixedly connected by a fastener, the fastener passes through the positioning component.

In the display device of the present application, the positioning component comprises a first mounting hole and a second mounting hole;
the first mounting hole is disposed on the connector, the second mounting hole is disposed on a side of the first backlight unit facing the second backlight unit, and the fastener passes through the first mounting hole and the second mounting hole to connect the connector and the first backlight unit.

In the display device of the present application, the first backlight unit comprises:
a first back plate comprising a first bottom plate and a first side plate formed by bending an edge of the first bottom plate, and the connector is connected with the first side plate.

### Beneficial Effect

The present application provides a splicing display module and a display device. In the splicing display module, an auxiliary display panel is arranged in the first splicing seam formed between the first display unit of the first liquid crystal display module and the second display unit of the second liquid crystal display module. Two opposite ends of the auxiliary display panel are respectively connected with the first display unit and the second display unit, so that light-emitting display can also be realized at the first splicing seam. Thus, a seam formed between the first liquid crystal display module and the second liquid crystal display module is visually eliminated. In addition, a connector is provided between the auxiliary display panel and the first backlight unit. In this way, the auxiliary display panel is fixed. This avoids relative movement between the auxiliary display panel and the first liquid crystal display module or the second liquid crystal display module, and prevents the auxiliary display panel from shifting. Therefore, a structural stability of the splicing display module can be enhanced, and the display performance can be improved.

### DESCRIPTION OF DRAWINGS

The technical solutions and other beneficial effects of the present application will be apparent through the detailed description of the specific embodiments of the present application in conjunction with the accompanying drawings.

FIG. 1 is a schematic three-dimensional structural diagram of a splicing display module provided by an embodiment of the present application.

FIG. 2 is a schematic top-view structural diagram of a splicing display module provided by an embodiment of the present application.

FIG. 3 is a schematic three-dimensional structural diagram of a splicing display module provided by another embodiment of the present application.

FIG. 4 is a schematic cross-sectional view of the splicing display module in FIG. 3 of the present application.

FIG. 5 is a schematic structural diagram of a connector of a splicing display module provided by another embodiment of the present application.

FIG. 6 is a schematic cross-sectional view of a positioning component of a splicing display module according to an embodiment of the present application.

FIG. 7 is a schematic cross-sectional view of a positioning component of a splicing display module according to another embodiment of the present application.

FIG. 8 is a schematic three-dimensional structural diagram of a splicing display module provided by another embodiment of the present application.

FIG. 9 is another cross-sectional schematic diagram of the splicing display module in FIG. 8 of the present application.

FIG. 10 is a schematic structural diagram of a splicing display module provided by another embodiment of the present application.

### DETAILED DESCRIPTION OF PREFERRED EMBODIMENTS

The technical solutions in the embodiments of the present application will be clearly and completely described below with reference to the accompanying drawings in the embodiments of the present application. Obviously, the described embodiments are only a part of the embodiments of the present application, but not all of the embodiments. Based on the embodiments in the present application, all other embodiments obtained by those skilled in the art without creative work fall within the protection scope of the present application.

In the description of the present application, it is to be understood that the terms “first” and “second” features may expressly or implicitly include one or more of the features. In the description of this application, “plurality” means two or more, unless expressly and specifically defined otherwise. It should be noted that, unless otherwise expressly specified and limited, the terms “linked” and “connected” should be understood in a broad sense, for example, it may be directly connected, or indirectly connected through an intermediate medium, or the internal connection of two elements or the interaction of two elements. For those of ordinary skill in the art, the specific meanings of the above terms in this application can be understood according to specific situations.

The following disclosure provides many different embodiments or examples for implementing different structures of the present application. To simplify the disclosure of the present application, the components and arrangements of specific examples are described below. Of course, they are only examples and are not intended to limit the application. Furthermore, this application may repeat reference numerals and/or reference letters in different instances. This repetition is for the purpose of simplicity and clarity and does not in itself indicate a relationship between the various embodiments and/or arrangements discussed. In addition, this application provides examples of various specific processes and materials. However, one of ordinary skill in the art would appreciate the application of other processes and/or the use of other materials.

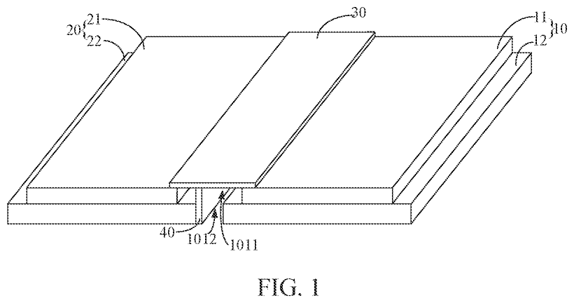

Referring to FIG. 1 to FIG. 10, an embodiment of the present application provides a splicing display module including a first liquid crystal display module 10, a first liquid crystal display module 10, an auxiliary display panel 30, and a connector 40.

The first liquid crystal display module 10 includes a first display unit 11 and a first backlight unit 12, and the first display unit 11 is disposed on the first backlight unit 12.

The second liquid crystal display module 20 includes a second display unit 21 and a second backlight unit 22. The second display unit 21 is disposed on the second backlight unit 22. The first display unit 11 and the second display unit 21 are arranged at intervals to form a first splicing seam 1011. It should be noted that the second liquid crystal display module 20 and the second liquid crystal display module 20 may have the same structure. Therefore, the connector 40 may be connected to the first liquid crystal display module 10 or may be connected to the second liquid crystal display module 20. All of this can achieve a fixed role for the auxiliary display panel 30.

The auxiliary display panel 30 is located in the first splicing seam 1011. The opposite ends of the auxiliary display panel 30 are respectively connected with the first display unit 11 and the second display unit 21. Exemplarily, both ends of the auxiliary display panel 30 are respectively disposed on the surfaces of the edges of the first display unit 11 and the second display unit 21. In order to achieve the effect of visually eliminating the seam formed between the first liquid crystal display module 10 and the second liquid crystal display module 20 to the greatest extent.

Specifically, as shown in FIG. 1 and FIG. 9, the first display unit 11 includes a first color filter substrate 103 and a first array substrate 101 that are disposed opposite to each other. A first liquid crystal layer 102 is disposed between the first color filter substrate 103 and the first array substrate 101. A first sealant 104 is provided on the surrounding edges of the first color filter substrate 103 and the first array substrate 101 for sealing the first liquid crystal layer 102. Correspondingly, the second display unit 21 includes a second color filter substrate 203 and a second array substrate 201 disposed opposite to each other. A second liquid crystal layer 202 is disposed between the second color filter substrate 203 and the second array substrate 201. A second sealant 204 is provided on the peripheral edges of the second color filter substrate 203 and the second array substrate 201 for sealing the second liquid crystal layer 202. The first array substrate 101 and the second array substrate 201 include thin film transistors (TFTs) arranged in an array, which are respectively used to drive the first liquid crystal layer 102 and the second liquid crystal layer 202 to work. Two ends of the auxiliary display panel 30 are respectively disposed on the surfaces of the first color filter substrate 103 and the second color filter substrate 203. The orthographic projection of the auxiliary display panel 30 on the first display unit 11 covers the first sealant 104, and the orthographic projection of the auxiliary display panel 30 on the second display unit 21 covers the second sealant 204. Since the sealants of the first display unit 11 and the second display unit 21 cannot emit light, the auxiliary display panel 30 is overlapped on the first sealant 104 and the second sealant 204. Therefore, the effect of visually eliminating the seam formed between the first liquid crystal display module 10 and the second liquid crystal display module 20 can be achieved to the greatest extent.

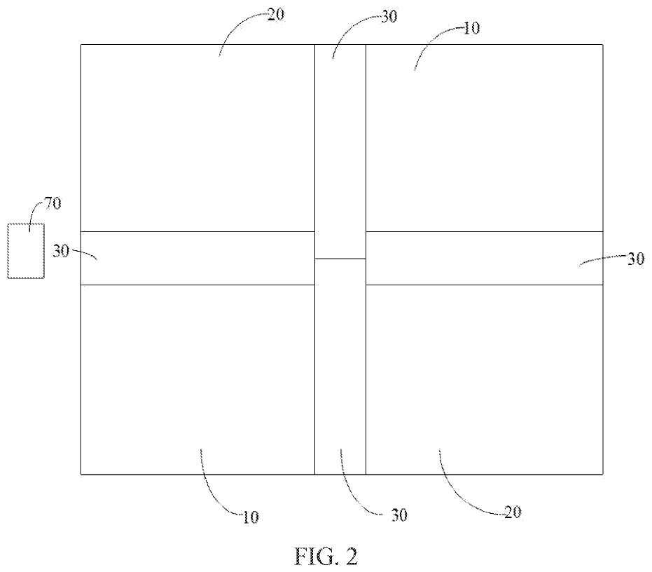

The auxiliary display panel 30 may be an organic light-emitting diode (OLED) display panel, a mini-LED display panel or a micro-LED display panel, or the like. As shown in FIG. 2, the number of the first liquid crystal display module 10 and the first liquid crystal display module 10 may be multiple. Correspondingly, there will also be multiple first splicing seams 1011 between the first liquid crystal display module 10 and the first liquid crystal display module 10. Therefore, the number of auxiliary display panels 30 may also be set to multiple. The first liquid crystal display modules 10 and the first liquid crystal display modules 10 are alternately arranged. The first liquid crystal display module 10 and the first liquid crystal display module 10 may be distributed in an “N×N” matrix, for example, a “2×2” matrix, a “1×4” matrix, a “6×6” matrix, etc.

As shown in FIG. 4, one end of the connector 40 is connected to the auxiliary display panel 30, and the other end of the connector 40 is connected to the first backlight unit 12. The connector 40 may be a plate-like structure, a net-like structure, a column-like structure, or the like. The contact area between the connector 40 and the first backlight unit 12 can be increased by disposing the connector 40 in a plate-like structure. Therefore, the structural stability between the auxiliary display panel 30 and the first backlight unit 12 can be better improved. The connector 40 may be a plastic member. The plastic member has good insulation and machinability, which facilitates the realization of various structural designs of the connector 40. It can be understood that the connector 40 is not limited to a plastic member. The connector 40 may also be made of other materials, for example, the connector 40 may be a metal piece such as an aluminum alloy piece, a stainless-steel alloy piece, or the like.

In the splicing display module of the embodiment of the present application, in the first splicing seam 1011 formed between the first display unit 11 of the first liquid crystal display module 10 and the second display unit 21 of the second liquid crystal display module 20, the auxiliary display panel 30 is provided. Two opposite ends of the auxiliary display panel 30 are respectively connected to the first display unit 11 and the second display unit 21. This enables light-emitting display to be realized at the first splicing seam 1011, thereby visually eliminating the seam formed between the second liquid crystal display module 20 and the second liquid crystal display module 20. In addition, a connector 40 is provided between the auxiliary display panel 30 and the first backlight unit 12. In this way, the auxiliary display panel 30 is fixed. This avoids relative movement between the auxiliary display panel 30 and the first liquid crystal display module 10 or the second liquid crystal display module 20, and prevents the auxiliary display panel 30 from shifting. Therefore, the structural stability of the splicing display module can be enhanced, and the display performance can be improved.

In some embodiments, as shown in FIG. 2, the tiled display module further includes a display control device 70. The display control device 70 is electrically connected to the first liquid crystal display module 10, the second liquid crystal display module 20, and the auxiliary display panel 30. The display control device 70 is used to control a synchronous display of the first liquid crystal display module 10, the second liquid crystal display module 20, and the auxiliary display panel 30. This enables the first liquid crystal display module 10, the second liquid crystal display module 20, and the auxiliary display panel 30 to jointly display a complete picture.

The display control device 70 may include a video processing card. The image is divided into a display portion of the first display unit 11, a display portion of the second display unit 21, and the auxiliary display panel 30 by the video processing card. Then, the display portion of the first display unit 11, the display portion of the second display unit 21, and the auxiliary display panel 30 are driven to display synchronously by a driver, so as to achieve the purpose of eliminating the visual influence of the frame.

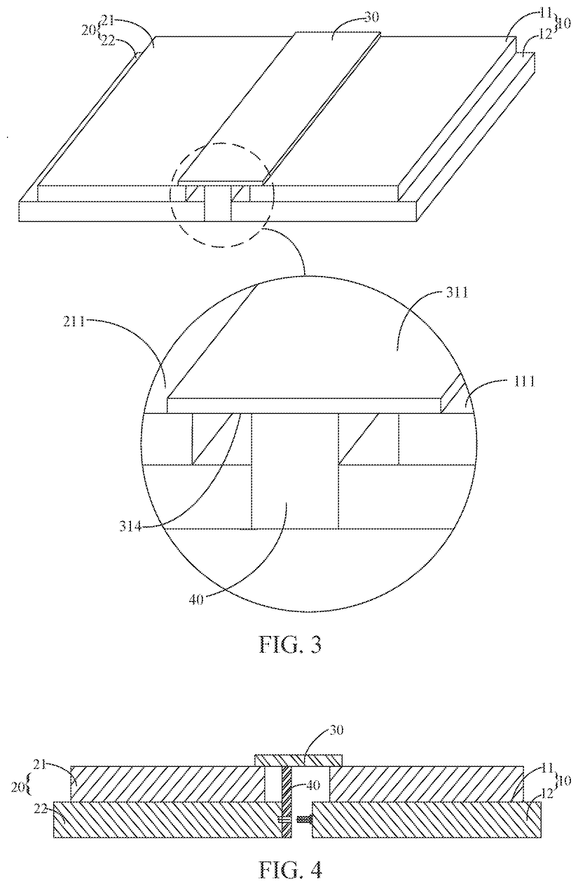

In some embodiments, as shown in FIG. 3, the first display unit 11 has a first light-emitting surface 111. The first light-emitting surface 111 is disposed away from the first backlight unit 12. Correspondingly, the second display unit 21 has a second light-emitting surface 211. The second light-emitting surface 211 is disposed away from the second backlight unit 22. The auxiliary display panel 30 includes a third light-emitting surface 311 and a backlight surface 314 which are arranged opposite to each other. The connector 40 is disposed on the backlight surface 314. The connector 40 is arranged on the backlight surface 314 so as not to affect the light output, so as to ensure the display performance of the splicing display module.

In some embodiments, both ends of the auxiliary display panel 30 are respectively overlapped with edges of the surfaces of the first light-emitting surface 111 and the second light-emitting surface 211. The edges of the surfaces of the first light-emitting surface 111 and the second light-emitting surface 211 do not emit light. Therefore, the effect of visually eliminating the seam formed between the first liquid crystal display module 10 and the second liquid crystal display module 20 can be achieved to the greatest extent.

In some embodiments, the connector 40 may be a plate-like connector 40. As shown in FIG. 1, the width of the connector 40 may be smaller than the width of the second splicing seam 1012. That is, one side surface of the connector 40 may be in contact with the first backlight unit 12, and the opposite side surface may be disposed at intervals from the second backlight unit 22. Therefore, the thickness of the connector 40 can be reduced, which is beneficial to the realization of the lightweight of the entire mosaic display module. Of course, as shown in FIG. 3, the width of the connector 40 may be equal to the width of the second splicing seam 1012. That is, the two opposite side surfaces of the connector 40 are respectively abutted against the first backlight unit 12 and the second backlight unit 22. This increases the contact area between the connector 40 and the auxiliary display panel 30. Thus, the structural stability between the auxiliary display panel 30 and the first liquid crystal display module 10 or the second liquid crystal display module 20 is further improved.

In some embodiments, as shown in FIG. 5, the connector 40 includes a first connection portion 41 and a second connection portion 42 which are arranged to cross each other. Specifically, the first connection portion 41 and the second connection portion 42 may be arranged perpendicular to each other. Exemplarily, the first connection portion 41 is arranged along the horizontal direction X, and the second connection portion 42 is arranged along the vertical direction Y. The normal of the first connection portion 41 and the normal of the backlight surface 314 are arranged in the same direction. Correspondingly, the backlight surface 314 is also disposed along the horizontal direction X, and the first connection portion 41 is bonded to the backlight surface 314. The two surfaces of the first connection portion 41 and the backlight surface 314 may be arranged parallel to each other. The first connection portion 41 and the second connection portion 42 are both flat plate structures. The first connection portion 41 and the second connection portion 42 may be arranged in a similar inverted “L” shape. The first connection portion 41 and the second connection portion 42 are integrally formed, so as to ensure the structural strength of the connecting piece 40. In addition, the second connection portion 42 is in contact with the first backlight unit 12 and the second connection portion 42 is spaced apart from the second backlight unit 22. Therefore, while the first connection portion 41 increases the contact area between the backlight surface 314 and the connector 40, the materials used for the supporting member can be saved. This is conducive to the realization of the lightweight of the splicing display module.

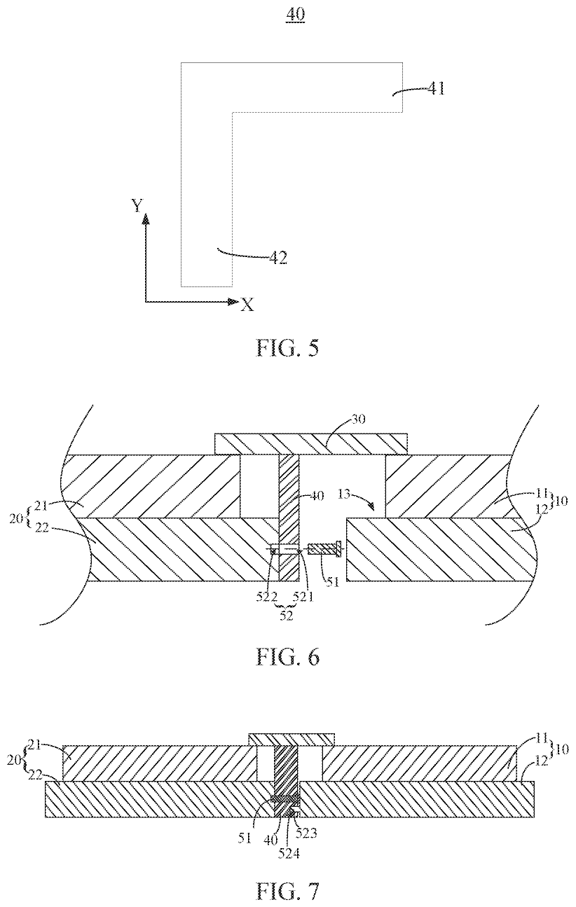

In some embodiments, as shown in conjunction with FIG. 1 and FIG. 6, the first backlight unit 12 and the second backlight unit 22 are spaced apart to form a second splicing seam 1012. Part of the connector 40 is placed in the first splicing seam 1011 and part thereof is placed in the second splicing seam 1012. The orthographic projection area of the first display unit 11 on the first backlight unit 12 is smaller than that of the first backlight unit 12. The edge of the first display unit 11 and the edge of the first backlight unit 12 form a stepped portion 13. The orthographic projection area of the second display unit 21 on the second backlight unit 22 is smaller than that of the second backlight unit 22, so the gap of the first splicing seam 1011 is larger than that of the second splicing seam 1012. By placing the connector 40 partially in the first splicing seam 1011 and partly in the second splicing seam 1012, it is convenient to install the connector 40 on the side of the first display unit 11, and the installation efficiency is improved.

In some embodiments, as shown in FIG. 6, the connector 40 and the first backlight unit 12 are positioned and matched and fixedly connected by a fastener 51. The fastener 51 passes through the positioning component 52 to fix the first liquid crystal display module 10 and the auxiliary display panel 30. Therefore, it is convenient to ensure the component precision of the first liquid crystal display module 10 and the auxiliary display panel 30. The fastener 51 can ensure that the positioning component 52 is reliably matched. In addition, the quick installation of the fastener 51 is facilitated. This is beneficial to improve the component efficiency of the first liquid crystal display module 10 and the auxiliary display panel 30. The fasteners 51 may be bolts or adhesive layers or other components capable of fastening.

In some embodiments, with continued reference to FIG. 6, the fastener 51 may be a threaded fastener. Taking the fastener 51 as a bolt as an example, the positioning component 52 includes a first mounting hole 521 and a second mounting hole 522. The first mounting hole 521 is provided on the connector 40, and the second mounting hole 522 is provided on the side of the first backlight unit 12 facing the second backlight unit 22. The fasteners 51 pass through the first mounting holes 521 and the second mounting holes 522 to connect the connector 40 and the side wall. Fasteners 51 may also include bolts and nuts. Bolts and nuts are threaded. The first mounting hole 521 and the second mounting hole 522 are both through holes. Alternatively, the wall surface of the first mounting hole 521 and/or the wall surface of the second mounting hole 522 is provided with threads. The fastener 51 is engaged with the threads of the first mounting hole 521 and/or the second mounting hole 522. Thus, the first liquid crystal display module 10 and the auxiliary display panel 30 are fixedly connected.

In some embodiments, as shown in FIG. 7, the positioning component 52 may further include a third mounting hole 524 and a positioning protrusion 523. The third mounting hole 524 is disposed on one of the connector 40 and the second backlight unit 22. Correspondingly, the positioning protrusion 523 is disposed on the other of the connector 40 and the second backlight unit 22. The third mounting hole 524 is matched with the positioning protrusion 523. Exemplarily, the third mounting hole 524 may be provided on the connector 40, and the positioning protrusion 523 may be provided on the second backlight unit 22. The positioning protrusion 523 may be a columnar structure or a cone-shaped structure. Taking the positioning protrusion 523 as an example of a columnar structure, the positioning protrusion 523 may be a cylinder or a prismatic structure such as a triangular prism, a quadrangular prism, a pentagonal prism, etc., and the structure of the positioning protrusion 523 is not specifically limited herein. Correspondingly, the third mounting hole 524 may also be a round hole, a square hole, or other polygonal holes, etc., which is not specifically limited here. Of course, it can be understood that the third mounting hole 524 may also be provided on the second backlight unit 22, and the positioning protrusion 523 may be provided on the connector 40.

Through the arrangement of the third mounting hole 524 and the positioning protrusion 523, the first liquid crystal display module 10 and the auxiliary display panel 30 can be fixedly connected through the connector 40. When the second liquid crystal display module 20 is installed on the connector 40, the third mounting hole 524 and the positioning protrusion 523 can quickly achieve positioning, thereby improving the installation efficiency.

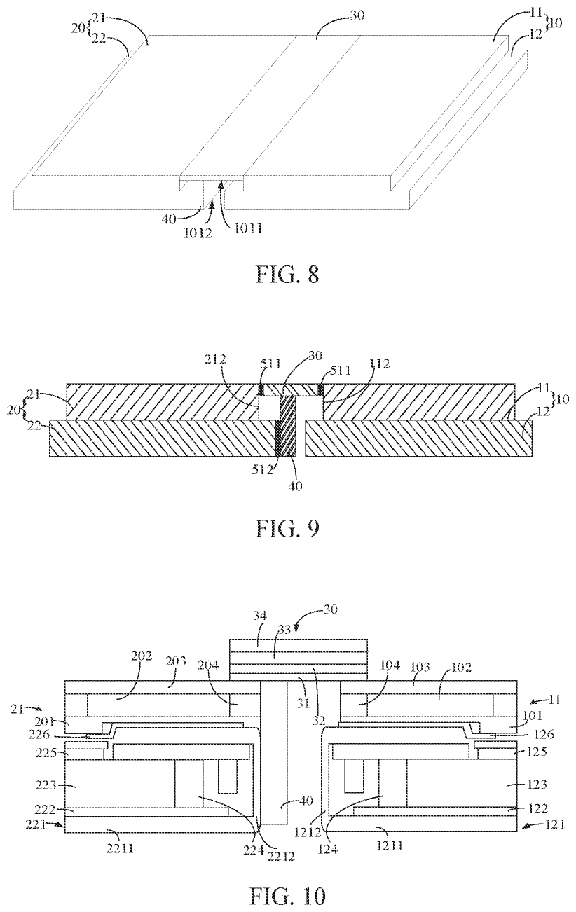

In some embodiments, as shown in FIG. 3 and FIG. 8, the first light-emitting surface 111, the second light-emitting surface 211, and the third light-emitting surface 311 may be arranged flush. Thus, the display differences of different light-emitting surfaces at different angles are reduced, and the display uniformity of the splicing display module is improved.

Referring to FIG. 9, when the two opposite sides of the connector 40 are respectively in contact with the first backlight unit 12 and the second backlight unit 22, the first backlight unit 12, the second backlight unit 22, and the connector 40 may use an adhesive connection. That is, the fastener 51 may be the adhesive layer 511. The material of the adhesive layer 511 is an optically transparent adhesive material. For example, it can be OCA (optically clear adhesive) optical adhesive, SCA optical adhesive, ionic intermediate film (surper safe glass, SGP), liquid optical adhesive LOCA (liquid optical clear adhesive), etc., and the material of the adhesive layer 511 is not specifically limited here.

Specifically, the auxiliary display panel 30 includes the opposite first side 112 and the second side 212. The first display unit 11 and the first side surface 112 are bonded by the optical adhesive 512. The first display unit 11 and the second side surface 212 are bonded by the optical adhesive 512. The optical adhesive 512 may be, for example, OCA (optically clear adhesive) optical adhesive, SCA optical adhesive, ionic intermediate film (surper safe glass, SGP), liquid optical adhesive LOCA (Liquid Optical Clear Adhesive), and the like. The first display unit 11 and the second display unit 21 are respectively connected to the auxiliary display panel 30 through the first side surface 112 and the second side surface 212. Therefore, the auxiliary display panel 30 can be further limited in position, thereby preventing the auxiliary display panel 30 from shifting, which is beneficial to improve the display performance of the splicing display module.

In some embodiments, as shown in FIG. 10, the first backlight unit 12 further includes a first back plate 121. The first back plate 121 includes a first bottom plate 1211 and a first side plate 1212 formed by bending an edge of the first bottom plate 1211. The connector 40 is connected to the first side plate 1212. The first backlight unit 12 includes, from bottom to top, a first back plate 121, a first excitation light source 124 located on a side of the first back plate 121, a first reflection sheet 122, a first light guide plate 123, a first optical film 125, a first plastic frame 126, and the first display unit 11 disposed on the first plastic frame 126.

Correspondingly, the second backlight unit 22 further includes a second back plate 221. The second back plate 221 includes a second bottom plate 2211 and a second side plate 2212 formed by bending an edge of the second bottom plate 2211. The connector 40 may be connected to the second side plate 2212 or be spaced apart from the second side plate 2212. The second backlight unit 22 includes, from bottom to top, a second back plate 221, a second excitation light source 224 located on the side of the second back plate 221, a second reflection sheet 222, a second light guide plate 223, a second optical film 225, a second plastic frame 226, and the second display unit 21 disposed on the second plastic frame 226.

In the first backlight unit 12, the first back plate 121 can play a supporting and fixing role for the first display unit 11 and has good structural stability. In addition, the side of the first side plate 1212 of the first back plate 121 facing away from the first excitation light source 124 will not be provided with other structures. Therefore, arranging the connector 40 on the first side plate 1212 can ensure the stability of the connection while making full use of the space of the first liquid crystal display module 10 and has a compact structure.

Taking the auxiliary display panel 30 as a top emission OELD display panel as an example, the auxiliary display panel 30 may include a substrate 31, a driving circuit layer 32, an organic light-emitting layer 33, and an encapsulation layer 34 arranged in order from top to bottom. The connector 40 can be connected to the substrate 31 so as not to affect the light-emitting display of the OLED display panel.

In order to better implement the splicing display module of the present application, an embodiment of the present application further provides a display device, and the display device includes the splicing display module described above. Since the display device has the above-mentioned splicing display module, it has all the same beneficial effects, which will not be repeated in this embodiment. The embodiments of the present application do not specifically limit the application of the display device, which may be any product or component with a display function, such as TV, laptop, tablet, mobile phone, movie screen, stage screen, outdoor screen, a vehicle-mounted display, an advertising light screen, and the like.

In the above embodiments, the description of each embodiment has its own emphasis. For parts that are not described in detail in a certain embodiment, reference may be made to related descriptions of other embodiments. During specific implementation, the above units or structures can be implemented as independent entities, or can be arbitrarily combined to implement as one or several entities. For the specific implementation of the above units or structures, reference may be made to the foregoing method embodiments, and details are not described herein again.

The splicing display module and the display device provided by the embodiments of the present application have been described in detail above. Specific examples are used herein to illustrate the principles and implementations of the embodiments of the present application. The descriptions of the above embodiments are only used to help understand the technical solutions and core ideas of the embodiments of the present application. Those of ordinary skill in the art should understand that they can still make modifications to the technical solutions described in the foregoing embodiments, or perform equivalent replacements to some of the technical features. However, these modifications or substitutions do not make the essence of the corresponding technical solutions deviate from the scope of the technical solutions of the embodiments of the present application.

What is claimed is:

1. A splicing display module, comprising:
a first liquid crystal display module comprising a first display unit and a first backlight unit, wherein the first display unit is disposed on the first backlight unit;
a second liquid crystal display module comprising a second display unit and a second backlight unit, wherein the second display unit is disposed on the second backlight unit, the first display unit and the second display unit are disposed at intervals to form a first splicing seam;
an auxiliary display panel located in the first splicing seam, wherein two opposite ends of the auxiliary display panel are respectively connected with the first display unit and the second display unit;
a connector, wherein an end of the connector is connected with the auxiliary display panel, and another end of the connector is connected with the first backlight unit.

2. The splicing display module according to claim 1, wherein the splicing display module further comprises:
a positioning component disposed on the connector and the first backlight unit, wherein the connector and the first backlight unit are positioned and matched and are fixedly connected by a fastener, the fastener passes through the positioning component.

3. The splicing display module according to claim 2, wherein the positioning component comprises a first mounting hole and a second mounting hole;
the first mounting hole is disposed on the connector, the second mounting hole is disposed on a side of the first backlight unit facing the second backlight unit, and the fastener passes through the first mounting hole and the second mounting hole to connect the connector and the first backlight unit.

4. The splicing display module according to claim 2, wherein the fastener is a threaded fastener, and the fastener is threadedly connected with the positioning component.

5. The splicing display module according to claim 3, wherein the positioning component comprises:
a third mounting hole disposed on one of the connector and the second backlight unit;
a positioning protrusion disposed on the other of the connector and the second backlight unit, and the third mounting hole is matched with the positioning protrusion.

6. The splicing display module according to claim 1, wherein the first backlight unit comprises:
a first back plate comprising a first bottom plate and a first side plate formed by bending an edge of the first bottom plate, and the connector is connected with the first side plate.

7. The splicing display module according to claim 6, wherein the second backlight unit comprises:
a second back plate comprising a second bottom plate and a second side plate formed by bending an edge of the second bottom plate.

8. The splicing display module according to claim 7, wherein the connector is connected with the second side plate or is disposed at a distance from the second side plate.

9. The splicing display module according to claim 1, wherein the first display unit has a first light-emitting surface, and the first light-emitting surface is disposed away from the first backlight unit;
the second display unit has a second light-emitting surface, and the second light-emitting surface is disposed away from the second backlight unit;
the auxiliary display panel comprises a third light-emitting surface and a backlight surface disposed opposite to each other, and the connector is disposed on the backlight surface.

10. The splicing display module according to claim 9, wherein two ends of the auxiliary display panel are respectively overlapped with edges of surfaces of the first light-emitting surface and the second light-emitting surface.

11. The splicing display module according to claim 9, wherein the connector comprises a first connection portion and a second connection portion disposed to cross each other, a normal line of the first connection portion and a normal line of the backlight surface are disposed in a same direction, the first connection portion is bonded to the backlight surface, and the second connection portion is connected to the first backlight unit.

12. The splicing display module according to claim 11, wherein the first connection portion and the second connection portion are integrally formed.

13. The splicing display module according to claim 1, wherein the first backlight unit and the second backlight unit are disposed at intervals to form a second splicing seam, a gap of the first splicing seam is larger than a gap of the second splicing seam, and the connector is partially disposed in the first splicing seam and partially disposed in the second splicing seam.

14. The splicing display module according to claim 1, wherein the connector is a plastic piece, and a shape of the connector is a plate-like structure, a net-like structure, or a column-like structure.

15. The splicing display module according to claim 1, wherein the splicing display module further comprises:
a display control device electrically connected to the first liquid crystal display module, the second liquid crystal display module, and the auxiliary display panel, wherein the display control device is used to control a synchronous display of the first liquid crystal display module, the second liquid crystal display module, and the auxiliary display panel.

16. The splicing display module according to claim 1, wherein the auxiliary display panel is a top-emitting OELD display panel;
the auxiliary display panel comprises a substrate, a driving circuit layer, an organic light-emitting layer, and an encapsulation layer disposed in sequence from top to bottom, and the connector is connected to the substrate.

17. A display device comprising a splicing display module, wherein the splicing display module comprises:
a first liquid crystal display module comprising a first display unit and a first backlight unit, wherein the first display unit is disposed on the first backlight unit;
a second liquid crystal display module comprising a second display unit and a second backlight unit, wherein the second display unit is disposed on the second backlight unit, the first display unit and the second display unit are disposed at intervals to form a first splicing seam;
an auxiliary display panel located in the first splicing seam, wherein two opposite ends of the auxiliary display panel are respectively connected with the first display unit and the second display unit;
a connector, wherein an end of the connector is connected with the auxiliary display panel, and another end of the connector is connected with the first backlight unit.

18. The display device according to claim 17, wherein the splicing display module further comprises:
a positioning component disposed on the connector and the first backlight unit, wherein the connector and the first backlight unit are positioned and matched and are fixedly connected by a fastener, the fastener passes through the positioning component.

19. The display device according to claim 18, wherein the positioning component comprises a first mounting hole and a second mounting hole;
the first mounting hole is disposed on the connector, the second mounting hole is disposed on a side of the first backlight unit facing the second backlight unit, and the fastener passes through the first mounting hole and the second mounting hole to connect the connector and the first backlight unit.

20. The display device according to claim 17, wherein the first backlight unit comprises:
a first back plate comprising a first bottom plate and a first side plate formed by bending an edge of the first bottom plate, and the connector is connected with the first side plate.
